(19) United States
(12) Patent Application Publication
(10) Pub. No.: US 2017/0086543 A1
(43) Pub. Date: Mar. 30, 2017

(54) Rotating Mechanism of Sunshade

(71) Applicant: Jianqiang Xie, Linhai City (CN)

(72) Inventor: Jianqiang Xie, Linhai City (CN)

(21) Appl. No.: 14/868,849

(22) Filed: Sep. 29, 2015

(51) Int. Cl. A45B 23/00; E04H 15/28; A45B 17/00

(52) U.S. Cl. CPC A45B 23/00; A45B 17/00; E04H 15/28; A45B 2017/005; A45B 2023/0075; F16C 11/04

(57) ABSTRACT

A rotating mechanism of a sunshade is disclosed to overcome the shortcomings of complicated structure, large weight, low stability, large package volume, high cost, and carrying hard in daily using according to the prior art. The rotating mechanism of a sunshade includes a sunshade canopy, a sunshade pole, a cantilever rod and a rotary device; wherein the rotary device is installed on a top end of the sunshade pole, the cantilever rod is detachably fixed to the rotary device, and the sunshade canopy is installed at one end of the cantilever rod; wherein the rotary device drives the sunshade canopy rotating around the sunshade pole via the cantilever rod.

### FIELD OF THE INVENTION

The present invention is related to mechanical technology, and more particularly to a rotating mechanism of a sunshade.

### BACKGROUND OF THE INVENTION

Since a shading area of a sunshade moves along with movement of the sun, the position of a sunshade canopy has to be constantly adjusted in order to obtain a stationary shading area. In the prior art, as described in the Chinese patent application (No. CN00211064.4), a sunshade canopy can be 360 degree rotated along with the rotation of a sunshade pole, and the sunshade pole can be rotated on its own axis via a rotary device disposed on a sunshade base. As shown in FIG. 1, the structure of the prior sunshade includes a sunshade base 101 and a fixing component used for fixing the sunshade pole on the sunshade base 101. The sunshade base 101 includes a rotary device 102 used for driving rotation of the sunshade pole. The rotary device 102 includes a rotary sleeve 103 supported and rotated by a bearing in the sunshade base 101. The rotary sleeve 103 has engaging teeth around its surface, which can engage or disengage with a teeth locking block 104 which has an up-down stroke. A reset spring 105 is further included under the block 104. It can be concluded that the prior sunshade has disadvantages of complicated structure, large weight, large package volume and high cost. In addition, because the sunshade canopy is rotated via the rotation of the sunshade pole disposed on the sunshade base, the stability is low and it is not easy to carry in daily using.

### SUMMARY OF THE INVENTION

In order to overcome the shortcomings of complicated structure, large weight, low stability, large package volume, high cost, and hard to be carried according to the prior sunshade, a rotating mechanism of a sunshade is proposed according to embodiments of the present invention.

According to an embodiment of the present invention, a rotating mechanism of a sunshade includes: a sunshade canopy, a sunshade pole, a cantilever rod and a rotary device; wherein the rotary device is installed on a top end of the sunshade pole, the cantilever rod is detachably fixed to the rotary device, and the sunshade canopy is installed at one end of the cantilever rod;
wherein the rotary device drives the sunshade canopy rotating around the sunshade pole via the cantilever rod.

According to embodiments of the present invention, by adjusting the rotation of the rotary device on its own axis, the cantilever rod is driven to rotate around the sunshade pole; meantime, the sunshade canopy installed at one end of the cantilever rod is also driven to 360-degree horizontally rotate around the sunshade pole, so that the shading area under the sunshade canopy can be adjusted according to movement of the sun. Since the sunshade pole is not rotated when the shading area is being adjusted, the structure of the rotary device disposed at the top end of the sunshade pole has not to be very complicated, so that the whole sunshade has advantages of simple structure, small size and light weight. In addition, since the cantilever rod can be detached from the rotary device, the whole sunshade is easy to carry and pack.

### BRIEF DESCRIPTION OF DRAWINGS

These and/or other aspects will become apparent and more readily appreciated from the following description of the embodiments, taken in conjunction with the accompanying drawings in which:

FIG. 1 illustrates a structure of a sunshade according to the prior art;

FIG. 2 illustrates a structure of a rotating mechanism of a sunshade according to an embodiment of the present invention;

FIG. 3 illustrates a structure of a rotary device in a rotating mechanism of a sunshade according to an embodiment of the present invention;

FIG. 4 illustrates a structure of a rotary device in a rotating mechanism of a sunshade according to an embodiment of the present invention;

FIG. 5 illustrates a structure of a rotary device in a rotating mechanism of a sunshade according to an embodiment of the present invention;

FIG. 6 illustrates a structure of a rotary device in a rotating mechanism of a sunshade according to an embodiment of the present invention;

FIG. 7 is a cross-sectional view of a structure of a rotary device in a rotating mechanism of a sunshade according to an embodiment of the present invention;

FIG. 8 illustrates a structure in a rotating mechanism of a sunshade according to an embodiment of the present invention; and

FIG. 9 is a cross-sectional view of a structure of a locking device in a rotating mechanism of a sunshade according to an embodiment of the present invention.

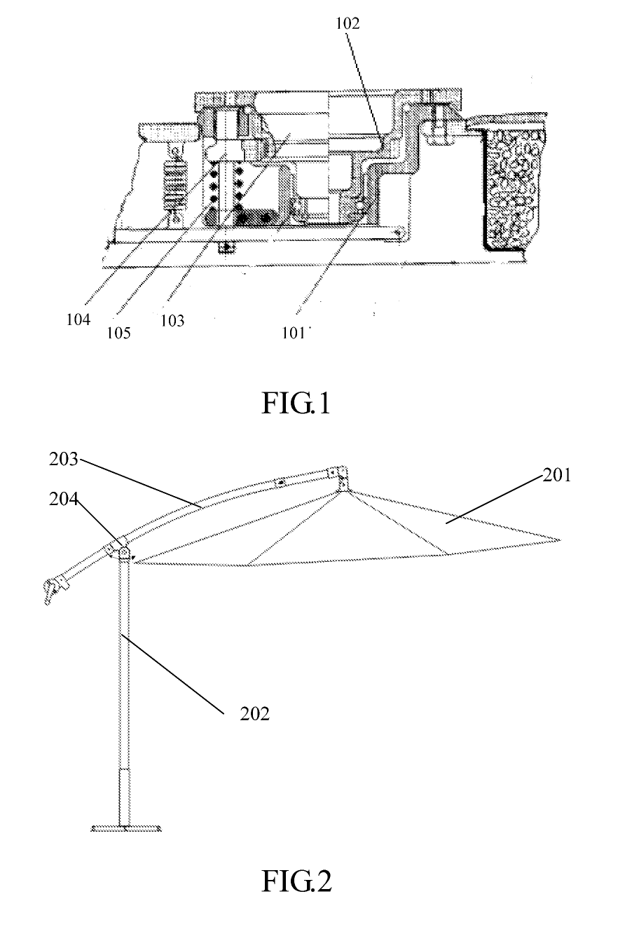

### DETAILED DESCRIPTION OF THE INVENTION

The embodiments of the present invention are described more fully hereinafter with reference to the accompanying drawings, which form a part hereof, and which show, by way of illustration, specific exemplary embodiments by which the invention may be practiced. Under the principle and the novel feature of the present invention, any modifications of structures, methods or functions are all considered to be within the protection scope of the present invention.

In addition, the same reference signs or symbols may be repeatedly used in different embodiments for clarity and simplicity. However, these reference signs or symbols repeatedly used cannot be used to limit the relationships of structures in different embodiments.

FIG. 2 illustrates a structure of a rotating mechanism of a sunshade according to an embodiment of the present invention.

As shown in FIG. 2, the rotating mechanism of the sunshade includes: a sunshade canopy 201, a sunshade pole 202, a cantilever rod 203 and a rotary device 204. The rotary device 204 is installed on a top end of the sunshade pole 202. The cantilever rod 203 is detachably fixed to the rotary device 204. The sunshade canopy 201 is installed at one end of the cantilever rod 203. For example, the sunshade canopy 201 may be hung at one end of the cantilever rod 203. When the rotary device 204 is rotated on its own axis, the rotary device 204 drives the sunshade canopy 201 rotating around the sunshade pole 202 via the cantilever rod 203 (as shown in the bi-directional arrows in FIG. 2).

Those skilled in the art can understand that the cantilever rod 203 may be screwed onto the rotary device 204, or fixed to the rotary device 204 via a dowel pin. The detailed detachably fixing manner between the cantilever rod 203 and the rotary device 204 is not limited thereto.

By adjusting the rotation of the rotary device 204 on its own axis, the cantilever rod 203 is driven to rotate around the sunshade pole 202; meantime, the sunshade canopy 201 installed at one end of the cantilever rod 203 is also driven to 360-degree horizontally rotate around the sunshade pole 202, so that the shading area under the sunshade canopy 201 can be adjusted according to movement of the sun. Since the sunshade pole 202 is not rotated when the shading area is being adjusted, the structure of the rotary device 204 disposed at the top end of the sunshade pole 202 has not to be very complicated, so that the whole sunshade has advantages of simple structure, small size and light weight. In addition, since the cantilever rod 203 can be detached from the rotary device 204, the whole sunshade is easy to carry and pack.

The internal structure of the rotary device 204 is described more fully hereinafter with the following embodiments.

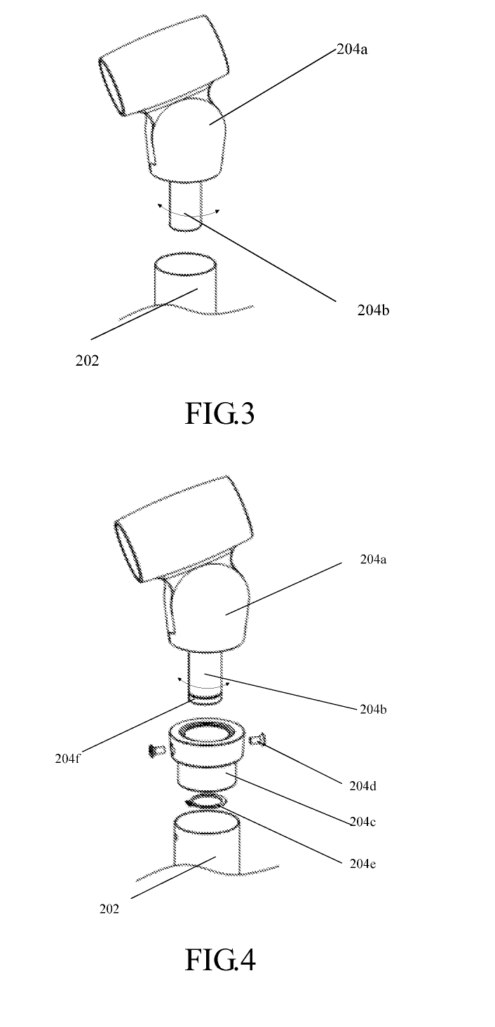

FIG. 3 illustrates a structure of a rotary device in a rotating mechanism of a sunshade according to an embodiment of the present invention.

As shown in FIG. 3, a rotary device 204 includes a rotating part 204a, and a sunshade pole 202 is hollow. The rotating part 204a has a rotating shaft 204b at the bottom thereof, and the rotating shaft 204b is sleeved in the sunshade pole 202 to form a revolute pair. Thus, compared with the prior rotary device which is disposed in the sunshade base, the rotary device 204 in the present invention has advantages of simple structure, small size, lightweight and low cost.

FIG. 4 illustrates a structure of a rotary device in a rotating mechanism of a sunshade according to an embodiment of the present invention.

As shown in FIG. 4, when the sunshade is being used or moved, a rotary device 204 may be detached from a hollow sunshade pole 202. In order to avoid the detachment of the rotary device 204, the rotary device 204 further includes a first bushing 204c, at least one fastener 204d and a check ring 204e. The first bushing 204c is sleeved in the sunshade pole 202, and fixed to the sunshade pole 202 via the at least one fastener 204d. The rotating shaft 204b is sleeved in the first bushing 204c to form a revolute pair. Meantime, the bottom of the rotating shaft 204b protrudes from the first bushing 204c, and a slot 204f is included at the bottom of the rotating shaft 204b. The check ring 204e is installed in the slot 204f, which is used to avoid the rotary device 204 from axially moving along with the first bushing 204c.

In this case, when the sunshade is being used or moved, even the rotating part 204a is under an axial tension, the axial moving of the rotating shaft 204b can be stopped by the check ring 204e, which is blocked at the bottom of the first bushing 204c, so that the detachment of the rotary device 204 from the hollow sunshade pole 202 is avoided.

Those skilled in the art can understand that the number of the at least one fastener 204d may be adjusted according to the size of the sunshade pole 202 and the fixing manner of the first bushing 204c. For example, in an embodiment of the present invention, as shown in FIG. 4, two through holes are included on a lateral surface of the sunshade pole 202, and two threaded holes are included on a lateral surface of the first bushing 204c and match the two through holes respectively. In this case, two screws may be applied as fasteners 204d. The first bushing 204c is fixed to the sunshade pole 202 by screwing the two screws from the two through holes into the two threaded holes respectively. In other embodiments, only one or more than two through holes may be included on the lateral surface of the sunshade pole 202, so only one or more than two screws may be applied as fasteners 204d. The number of the at least one fastener 204d and the fixing manner of the first bushing 204c is not limited thereto.

FIG. 5 illustrates a structure of a rotary device in a rotating mechanism of a sunshade according to an embodiment of the present invention.

As shown in FIG. 5, in order to decrease the rotating friction between a rotating part 204a and a first bushing 204c and increase the wear life of a rotating part 204a, a rotary device 204 further includes a second bushing 204g sleeved in the first bushing 204c. A rotating shaft 204b is sleeved in the second bushing 204g to form a revolute pair.

In an embodiment of the present invention, the second bushing 204g may be made of wear-resistant plastic. Those skilled in the art can understand that the second bushing 204g also may be made of bearing alloy, bronze, aluminum-based alloy, zinc-base alloy or the like. The material used for the second bushing 204g is not limited thereto.

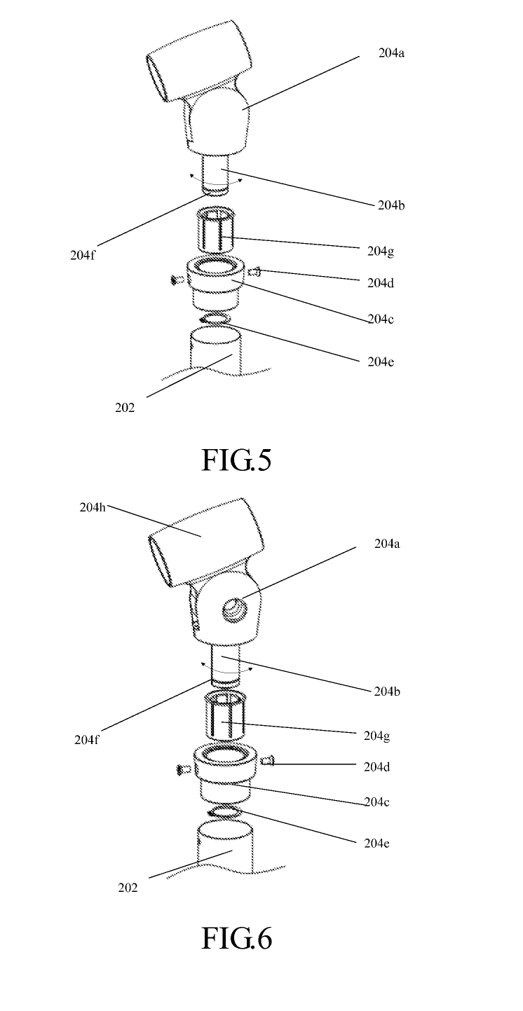

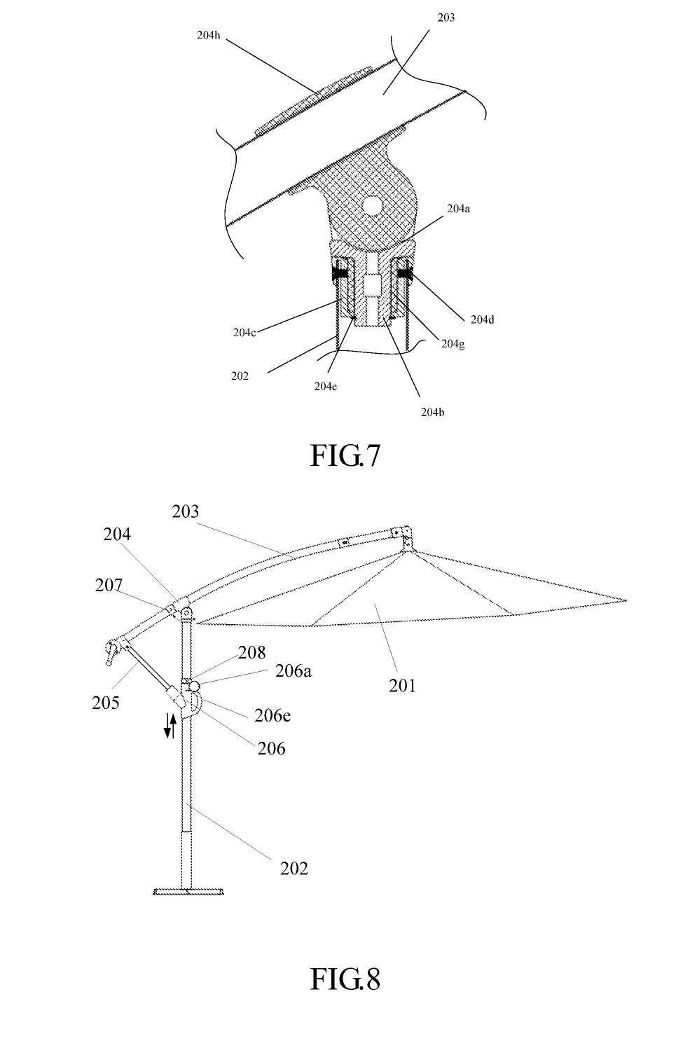

FIG. 6 illustrates a structure of a rotary device in a rotating mechanism of a sunshade according to an embodiment of the present invention. FIG. 7 is a cross-sectional view of a structure of a rotary device in a rotating mechanism of a sunshade according to an embodiment of the present invention.

As shown in FIG. 6 and FIG. 7, a rotary device 204 further includes a supporting part 204h. The supporting part 204h is articulated with a rotating part 204a. A cantilever rod 203 passes through the supporting part 204h to form a sliding pair. In this case, while the position of a sunshade canopy 201 is adjusted in a range of 360 degrees via the rotary device 204, the cantilever rod 203 can be concurrently rotated via the articulated connection between the rotating part 204a and the supporting part 204h. So the sunshade canopy 201 can be raised or lowered. Meanwhile, the distance between the sunshade canopy 201 and the sunshade pole 202 can also be adjusted by sliding the cantilever rod 203 in the supporting part 204h. In this case, comparing with the structure illustrated in the embodiment of FIG. 5, the adjusting range of the shading area under the sunshade canopy 201 is larger and the adjusting manner is more flexible.

FIG. 8 illustrates a structure in a rotating mechanism of a sunshade according to an embodiment of the present invention.

As shown in FIG. 8, in order to lock the position of a sunshade canopy 201 and the rotating angle of a cantilever rod 203, the rotating mechanism of the sunshade further includes a link rod 205 and a locking device 206. One end of the link rod 205 is articulated with a cantilever rod 203; the other end of the link rod 205 is articulated with the locking device 206. The locking device 206 is installed on the sunshade pole 202. Since no matter where the articulated connection between the link rod 205 and the cantilever rod 203 is set, the cantilever rod 203 can be driven by the link rod 205, so the position of the articulated connection between the link rod 205 and the cantilever rod 203 is not limited thereto.

When the locking device 206 is unlocked, the locking device 206 can be rotated on the axis of the sunshade pole 202, so that the link rod 205 can also be rotated around the sunshade pole 202. Meantime, the locking device 206 can be axially moved along with the sunshade pole 202, so the link rod 205 can also be rotated via the articulated connection between the link rod 205 and the locking device 206 to raise or lower the sunshade canopy 201.

When the locking device 206 is locked, the locking device 206 is fixed to the sunshade pole 202, so the link rod 205 which is articulated with the locking device 206 also cannot be moved or rotated. Thus the position of the sunshade canopy 201 and the rotating angle of the cantilever rod 203 are locked.

It can be concluded that the locking device 206 can also be used for adjusting the position of the sunshade canopy 201 and the rotating angle of the cantilever rod 203. In an embodiment of the present invention, to facilitate the adjustment via the locking device 206, a handle 206e is further included and fixed to the locking device 206, so that the position of the sunshade canopy 201 and the rotating angle of the cantilever rod 203 can be more easily adjusted via the handle 206e.

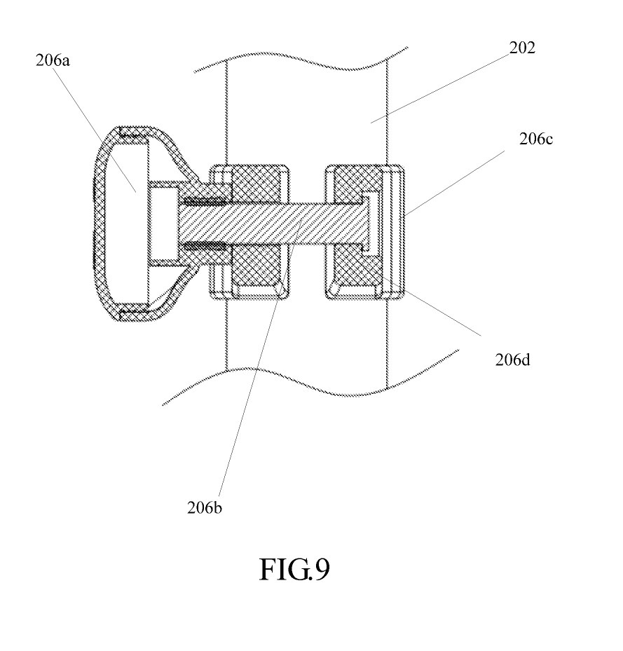

FIG. 9 is a cross-sectional view of a structure of a locking device in a rotating mechanism of a sunshade according to an embodiment of the present invention.

As shown in FIG. 9, a locking device 206 includes a locking knob 206a, a locking screw 206b and a locking piece 206c. The locking piece 206c has an opening 206d. A sunshade pole 202 is sleeved in the locking piece 206c. The locking screw 206b crosses through the opening 206d and is screwed into the locking knob 206a. Thus the locking of the locking piece 206c can be loosened or tightened by adjusting the gap of the opening 206d, and the gap of the opening 206d can be adjusted via the rotation of the locking screw 206b, which can be driven by the rotation of the locking knob 206a.

When a sunshade provided by an embodiment of the present invention is being used, the rotating angle of the locking device 206 can be firstly adjusted via the handle 206e which is fixed to the locking piece 206c, until the cantilever rod 203 and the sunshade canopy 201 are rotated to a suitable angle around the sunshade pole 202. Then, by moving the locking device 206 along with the sunshade pole 202 axially via the handle 206e, the sunshade canopy 201 is adjusted to a suitable height. By rotating the locking knob 206a, the position of the sunshade canopy 201 is fixed. When the shading area under the sunshade canopy 201 is needed to be changed, the locking device 206 has to be unlocked by inversely rotating the locking knob 206a in advance, and then the position of the sunshade canopy 201 can be changed by repeating the adjusting operations above.

In an embodiment of the present invention, as shown in FIG. 8, the rotating mechanism of the sunshade further includes a first limited block 207 and a second limited block 208. The first limited block 207 is fixed to the cantilever rod 203 to limit the axial movement of the cantilever rod 203. The second limited block 207 is fixed to the sunshade pole 202 to limit the axial movement of the locking device 206. However, the number, position and shape of the limited blocks are not limited thereto.

Those skilled in the art can understand that, the present invention is not limited to the details described in above embodiments. Under the principle and the novel feature of the present invention, the present invention may also be realized in other embodiments. Therefore, all the embodiments described above should be considered as preferable examples rather than limitations of the technical scheme of the present invention, any modifications under the principle and the novel feature of the present invention are all considered to be within the protection scope of the present invention. Furthermore, the reference signs or symbols used cannot be used for limiting the protection scope of the present invention.

Those skilled in the art can also understand that, although the present invention is described with embodiments for clarity, each embodiment may include more than one technical scheme. The embodiments described in the specification should be considered as a whole. Those skilled in the art may obtain other new embodiments by combing the technical schemes described in the embodiments of the specification.

1. A rotating mechanism of a sunshade, comprising: a sunshade canopy, a sunshade pole, a cantilever rod and a rotary device; wherein the rotary device is installed on a top end of the sunshade pole, the cantilever rod is detachably fixed to the rotary device, and the sunshade canopy is installed at one end of the cantilever rod;
wherein the rotary device drives the sunshade canopy rotating around the sunshade pole via the cantilever rod.

2. The rotating mechanism of the sunshade according to claim 1, wherein the rotary device comprises a rotating part having a rotating shaft at the bottom thereof, wherein the rotating shaft is sleeved in the sunshade pole to form a revolute pair.

3. The rotating mechanism of the sunshade according to claim 2, wherein the rotary device further comprises a first bushing, at least one fastener and a check ring;
wherein the first bushing is sleeved in the sunshade pole and fixed to the sunshade pole via the at least one fastener; the rotating shaft is sleeved in the first bushing to form a revolute pair;
wherein a bottom of the rotating shaft protrudes from the first bushing, and the check ring is installed in a slot disposed at the bottom of the rotating shaft, to avoid the rotary device from axially moving along with the first bushing.

4. The rotating mechanism of the sunshade according to claim 3, wherein at least one through hole is further formed on a lateral surface of the sunshade pole; at least one threaded hole is further formed on a lateral surface of the first bushing and matches the at least one through hole respectively; and at least one screw is applied as the at least one fastener;
wherein the first bushing is fixed to the sunshade pole by screwing the at least one screw from the at least one through hole into the at least one threaded hole respectively.

5. The rotating mechanism of the sunshade according to claim 3, wherein the rotary device further comprises a second bushing sleeved in the first bushing; the rotating shaft is sleeved in the second bushing to form a revolute pair.

6. The rotating mechanism of the sunshade according to claim 5, wherein the second bushing is made of wear-resistant plastic.

7. The rotating mechanism of the sunshade according to claim 5, wherein the rotary device further comprises a supporting part;
wherein the supporting part is articulated with the rotating part, and the cantilever rod passes through the supporting part to form a sliding pair.

8. The rotating mechanism of the sunshade according to claim 7, further comprising a link rod and a locking device; wherein one end of the link rod is articulated with the cantilever rod, and the other end of the link rod is articulated with the locking device; the locking device is installed on the sunshade pole;
wherein when the locking device is unlocked and the locking device is rotated on the axis of the sunshade pole, the link rod is rotated around the sunshade pole;
when the locking device is unlocked and the locking device is moved along with the sunshade pole axially, the link rod is rotated via the articulated connection between the link rod and the locking device to raise or lower the sunshade canopy;
when the locking device is locked, the locking device is fixed to the sunshade pole.

9. The rotating mechanism of the sunshade according to claim 8, wherein the locking device further comprises a locking knob, a locking screw and a locking piece;
wherein the locking piece has an opening; the sunshade pole is sleeved in the locking piece; the locking screw crosses through the opening and is screwed into the locking knob;
wherein the locking of the locking piece is loosened or tightened by adjusting the gap of the opening, and the gap of the opening is adjusted via the rotation of the locking screw, which is driven by the rotation of the locking knob.

10. The rotating mechanism of the sunshade according to claim 8, wherein the locking device further comprises a handle fixed to the locking device and used for facilitating the adjustment of a position of the sunshade canopy and a rotating angle of the cantilever rod via the locking device.
